(19) United States
(12) Patent Application Publication
(10) Pub. No.: US 2008/0074968 A1
(43) Pub. Date: Mar. 27, 2008

(54) SPARE AREA ALLOCATION SYSTEM AND METHOD

(75) Inventors: Shih-hsin Chen, Jhubei City (TW); Ching-wen Hsueh, Luodong Township (TW); Ying-che Hung, San-Chung City (TW)

Correspondence Address: MADSON & AUSTIN, 15 WEST SOUTH TEMPLE, SUITE 900, SALT LAKE CITY, UT, 84101, US

(73) Assignee: MEDIATEK Inc., Hsin-Chu City (TW)

(21) Appl. No.: 11/764,875

(22) Filed: Jun. 19, 2007

Related U.S. Application Data
(60) Provisional application No. 60/826,635, filed on Sep. 22, 2006.

(51) Int. Cl. G11B 5/09

(52) U.S. Cl. 369/47.14

(57) ABSTRACT

A spare area allocation method for an optical disc and a disc drive implementing this method. The disc has a plurality of spare areas. When a defect is found, weights are given to the respective spare areas according to various conditions such as seek time comparison, existence of old defect and host instruction for the defect. By comparing the final weight of the respective spare areas, the available spare area with the greatest final weight is selected. A replacement for the defect is then allocated to the selected spare area. By using this method, when a new defect is found, the most appropriate one of the spare areas can be selected to assign a replacement for the defect.

### TECHNICAL FIELD OF THE INVENTION

The present application relates to an optical disc defect management, and more particularly, to a spare area allocation system and method for spare areas for a defect of the optical disc and a disc drive implementing the allocation method.

### BACKGROUND OF THE INVENTION

An optical disc, such as a Blu-ray disc, usually has spare areas defined for recording some backup information including replacement for a registered defect. A single layer disc has two spare areas at the inner-most and outer-most edges of the disc. These two spare areas are referred to as ISA (inner spare area) and OSA (outer spare area). Similarly, a double layer disc has four spare areas. There are spare areas ISA0 and OSA0 on layer 0 of the double layer disc, and spare areas ISA1 and OSA1 on layer 1 thereof.

When a defect cluster is found in writing process for the disc, a cluster in one of the spare areas should be assigned to the defect as a replacement. That is, replacement for the defect is allocated to a cluster of one of the spare areas. The data of the defect cluster is recorded in the replacement cluster. When reading or writing is attempted on the defect cluster, the process is generally re-directed to the replacement cluster to access the data thereof.

A pick-up head of a disc drive needs to shift back and forth to seek the replacement in the spare area when the reading/writing process proceeds to the defect. The time required to access replacement can be reduced if the allocation of the replacement to which one of the spare areas is carefully considered. The present invention provides a method to properly select the spare area to allocate the replacement so as to enhance the accessing efficiency when reading/writing the disc.

### SUMMERY OF THE INVENTION

An objective of the present invention is to provide a spare area allocation method for an optical disc, which has a plurality of spare areas. By using embodiments of the present invention, when a new defect is found, the most appropriate one of the spare areas can be selected to allocate a replacement for the defect.

Another objective of the present invention is to provide a spare area allocation system for an optical disc drive which implements a method of spare area allocation method in accordance with embodiments of the present invention. When a defect is found, the disc drive can select the most appropriate one of the spare areas of a disc to allocate a replacement for the defect.

In accordance with an aspect of the present invention, in the spare area allocation method, when a defect is found, weights are given to the respective spare areas according to various conditions such as seek time comparison, existence of old defect and host instruction for the defect. By comparing the final weights of the respective spare areas, the available spare area with the greatest weights is selected. A replacement for the defect is assigned to the selected spare area.

In accordance with another aspect of the present invention, the spare area allocation system gives weights to respective spare areas of a disc according to various criteria such as seek time comparison, existence of old defect and host instruction. The system compares the final weighted sums of the respective spare areas, and selects the available spare area with the greatest weighted sum. A replacement for the defect is allocated to the selected spare area.

### BRIEF DESCRIPTION OF THE DRAWINGS

FIG. 1 is a block diagram schematically showing a disc drive with a spare area allocation system in accordance with the present invention;

FIG. 2 is a schematic diagram showing spare area allocation in accordance with an embodiment of the present invention, wherein access times to respective spare areas are compared;

FIG. 3 is a schematic diagram showing spare area allocation in accordance with an embodiment of the present invention, wherein access times to respective spare areas are compared and one of the spare areas is full;

FIG. 4 is a schematic diagram showing spare area allocation in accordance with an embodiment of the present invention, wherein existence of the nearest old defect is considered; and

FIG. 5 is a flow chart showing a spare area allocation method in accordance with an embodiment of the present invention.

### DETAILED DESCRIPTION OF THE PREFERRED EMBODIMENTS

Embodiments of the present invention will be described in detail in conjunction with the drawings. In the descriptions below, a double layer (DL) Blu-ray disc is described as an example, but the invention can be applied in other appropriate types of discs or Blu-ray discs having other number of layers. The DL Blu-ray disc has two layers, Layer 0 and Layer 1. The DL Blu-ray disc has four spare areas, spare areas ISA0, OSA0 on Layer 0, and spare areas ISA1, OSA1 on Layer 1.

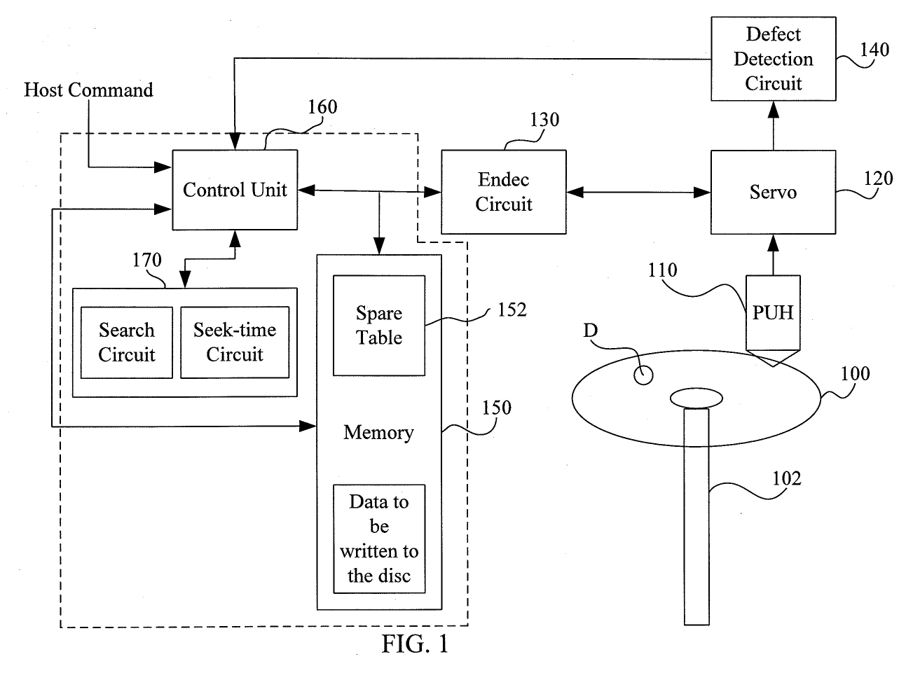

FIG. 1 is a block diagram schematically showing a disc drive with a spare area allocation system in accordance with the present invention. As schematically illustrated in FIG. 1, a formatted Blu-ray disc 100 with spare areas is carried by a spindle 102. A pick-up head 110 is used to read/write the disc. On the disc 100, D indicates a defect. The disc drive includes a servo 120 driving the pick-up head (PUH) 1110, and an endec (encoder/decoder) circuit 130 coupled with the servo 120 to encode the data to be written to the disc 100 or decode the data read from the disc 100. A defect detection circuit 140 is connected with the servo 120 to detect defects of the disc 100. The endec circuit 130 communicates with a memory 150 and a control unit such as a CPU 160. A spare area allocation system in accordance with the present invention comprises the memory 150 and the CPU 160. The memory 150 stores the data to be written to the disc 100 or data read from the disc 100. The endec circuit 130 is controlled by the CPU 160. In addition, the memory 150 further stores a spare table 152, which registers spare area information (spare table) of the disc 100. The spare area allocation system in accordance with an embodiment of the present invention further has a search and seek-time circuit 170. In this embodiment, the search and seek-time circuit 170 is a circuit block having the functions of estimating seek time from a new defect to each spare area, comparing the seek times for the respective spare areas, and searching for any old defects near the new defect. The search and seek-time circuit 170 can also be implemented as a set of a search circuit and a seek-time circuit. The search and seek-time circuit 170 can be a separate block or integrated into the CPU 160. When the defect detection circuit 140 detects a defect D, it notifies the CPU 160, and the CPU 160 instructs the search and seek-time circuit 170 to execute some operations so that the CPU 160 can select one of the spare areas to allocate a replacement for the defect D. The details thereof will be further described later. As mentioned, the search and seek-time circuit 170 can be an individual and separate block or integrated in the CPU 160 in hardware, firmware or software form.

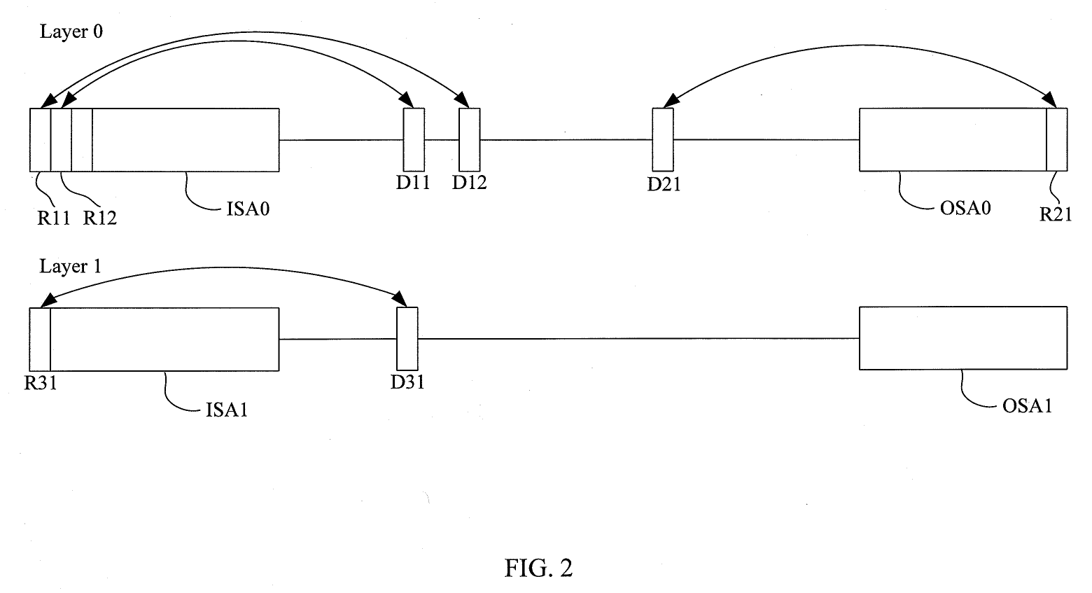

FIG. 2 is a schematic diagram showing spare area allocation in accordance with an embodiment of the present invention, wherein access times to respective spare areas are compared. As shown in the drawing, a replacement for a defect is assigned to the nearest one of the spare areas. That is, seek time from the defect to the replacement will be minimized. As shown, there are three defects D11, D12 and D21 found by the defect detection circuit 140 on Layer 0 of the disc 100. For defects D11 and D12, the nearest spare area is ISA0. That is, the seek time from the defects D11 and D12 to the estimated positions for the replacements in the spare area ISA0 are shortest as compared to other spare areas. The seek times are estimated and compared by the search and seek-time circuit 170. Therefore, replacements R11 and R12 for the defects D11 and D12 are allocated in ISA0. For defect D21, the nearest spare area is OSA0. Accordingly, a replacement R21 for the defect D21 is allocated in spare area OSA0. Similarly, a replacement R31 for the defect D31 is allocated in spare area ISA1 since ISA1 is the nearest spare area to the defect D31. In another embodiment, the search and seek-time circuit 170 only provides estimated seek time from the defect to each spare area without comparison, and the CPU 160 gives a weight to each spare area according to the estimated seek time.

The determination method described above is simple and effective. However, for a new defect, if the nearest spare area is full, one of the other spare areas should be selected to allocate a replacement for the defect.

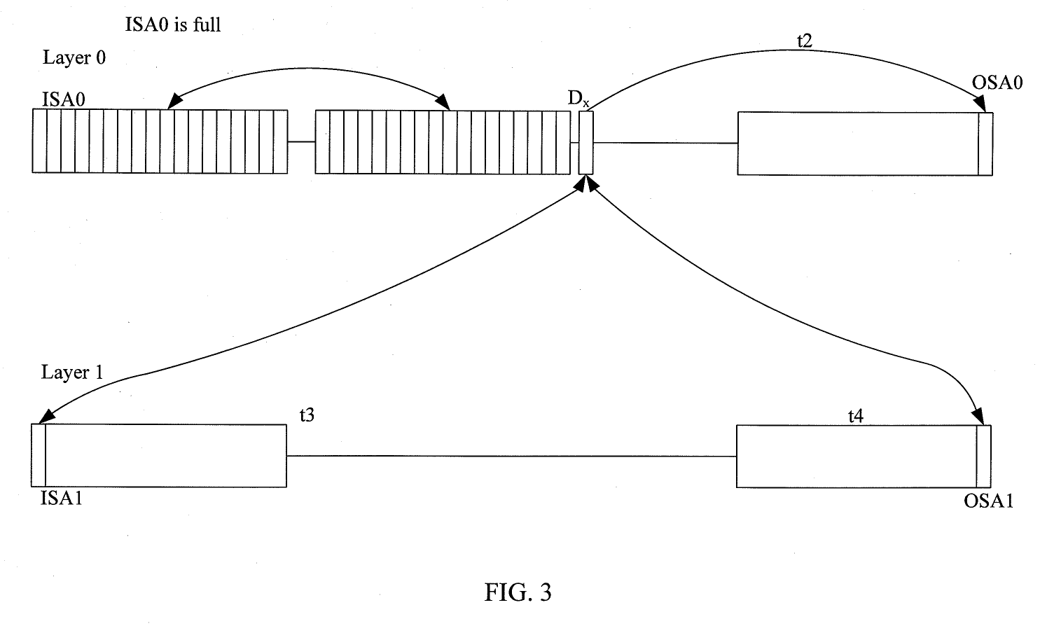

FIG. 3 is a schematic diagram showing spare area allocation in accordance with another embodiment of the present invention, wherein access times to respective spare areas are compared and one of the spare areas is full. In this example, ISA0 is full. Therefore, the disc drive needs to select one of the available spare areas OSA0, ISA1 and OSA1 to allocate a cluster of the spare area to a replacement Rx for the defect Dx. According to this embodiment, the search and seek-time circuit 170 estimates and compares seek times t2, t3, t4 for the defect Dx to the respective expected replacement positions of the spare areas OSA0, ISA1, OSA1 for the defect, so that the CPU 160 can determine which one of these three spare areas is the nearest one for the defect Dx.

There are many methods to estimate the seek time that can be used in the embodiments described above. One of these methods is described herein as an example. To calculate the seek time for the defect to a spare area, there are five items to be considered. The five items are seek period, jump-layer period, focus-on period, track-on period and address-decode period. The seek period is the time required for the pick-up head to shift from a current position to a destination position. The seek period can be obtained by simply calculating tracks between the current and destination positions. The jump-layer period is the time for the pick-up head to move from one layer to another layer. If shifting between layers does not occur, the jump-layer period is zero. For a single layer disc, it is not necessary to consider the jump-layer period. The focus-on period is the time required for the pick-up head to focus on a target. The track-on period is the time required for locking on the track. The address-decode period is the time required for decoding a physical address of the disc. By considering these periods above, the seek time can be simply estimated, so that a proper spare area can be selected.

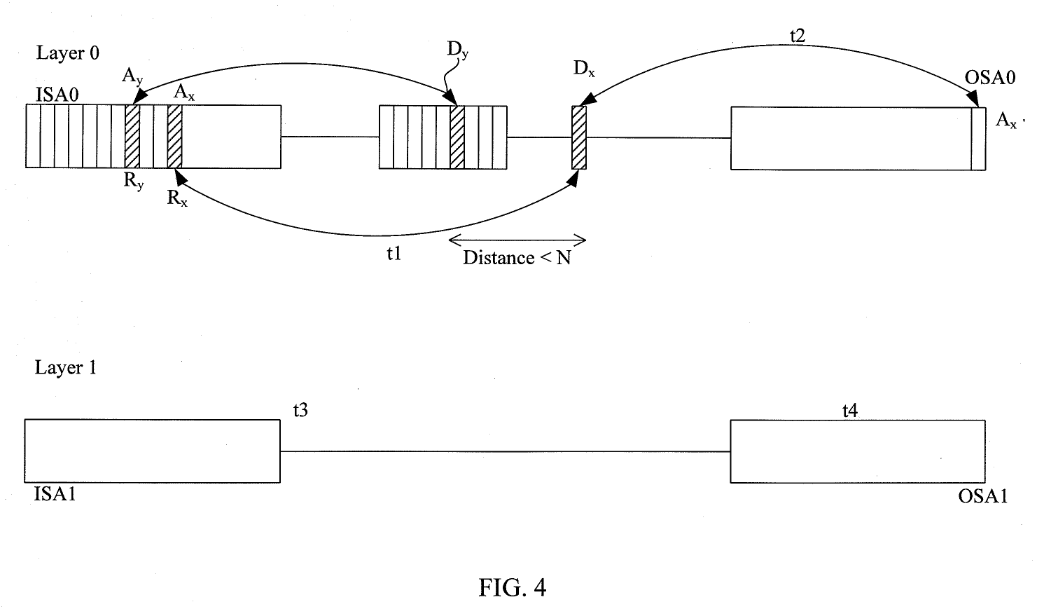

In addition to seek time, other factors can be considered in selecting a spare area when a new defect is found. FIG. 4 is a schematic diagram showing spare area allocation in accordance with another embodiment of the present invention, wherein existence of the nearest old defect is considered when a new defect Dx is found. Assuming that the seek time t1 from the defect Dx to an expected position Ax in the spare area ISA0 for allocating a replacement Rx for the defect Dx is longer than the seek time t2 from the defect Dx to an estimated position Ax′ in the spare area OSA0 for allocating the replacement Rx. If no other factors are considered, OSA0 should be selected since the position Ax′ is nearer than Ax to the defect Dx. That is, the replacement Rx of the defect Dx should be put into the position Ax′. However, according to the present embodiment, the search and seek-time circuit 170 further checks if there is an old defect cluster Dy existing in the vicinity of the defect Dx. In the illustrated example, the nearest old defect cluster Dy is located in a predetermined range (referred to as a dependency range) with respect to the new defect Dx. In addition, a replacement Ry for the defect Dy has already been put in a position Ay of the spare area ISA0. For a sequential reading mode, it may be advantageous that the replacement Rx of the defect Dx is also assigned to the spare area ISA0. For example, one defect management mechanism is to deal with the defects in batches. That is, when a defect is found, the defect is accumulated (e.g. registered in a buffer). When the number of the accumulated defects reaches a predetermined number (e.g. the buffer is full), then the disc drive deals with the accumulated defects at once. That is, the disc drive processes replacement clusters for those accumulated defects at once. Under such a circumstance, it is preferred that replacements for defects located in a limited range (e.g. the dependency range in the present embodiment) are allocated in the same spare area. The dependency range can be determined according to the capacity of the buffer for buffering the accumulated defects, for example.

In accordance with the present embodiment, the dependency range N is defined for determining dependency between the new defect and the old defect, which has been assigned with a replacement already. When the new defect Dx is found, the search and seek-time circuit 170 tries to find the nearest old defect in the range of +N clusters from Dx. If there is an old defect Dy existing in the dependency range with respect to the new defect Dx, then the replacement Rx for the new defect Dx is preferably allocated to the same spare area where the replacement Ry for the old defect Dy has been allocated.

More preferably, both the seek time and existence of old defect are considered. If the old defect Dy, which is the nearest one to the new defect Dx, is found in the dependency range with respect to the new defect Dx, the spare area where the replacement Ry for the old defect Dy is allocated is given a weight. In addition, seek times for the new defect Dx to the respective spare areas are compared and respectively given weights based on the comparison results. For each spare area, the given weights are summed as a final weight for this spare area. Selection among the spare areas can be made by considering the final weights of the respective spare areas.

If the selected spare area (the spare area having the greatest final weight) is not available (e.g. the spare area is full), it is eliminated, and the spare area with the second greatest final weight is selected. Alternatively, the spare area not available is eliminated in the beginning.

In a specific case, a host (not shown in the drawings) connected with the disc drive may designate a specific spare area for a defect. The host can uses a specific ATAPI command to instruct the disc drive. When the CPU 160 receives the host command for designating a specific spare area for the defect, the CPU 160 directly selects the designated spare area. Alternatively, the CPU 160 gives a weight to the specific spare area. Generally, when the host requests the CPU 160 to allocate a replacement for the defect to the specific spare area, such a request should be of the highest priority. Therefore, the weight associated with the request should be heavy.

Below is an example of various weights for the conditions described above. For a new defect Dx found on a DL disc having four spare areas, if the CPU 160 receives the command from the host to designate one specific spare area, then a weight of 2 is given for this specific area. If it is determined that the nearest old defect Dy about the new defect Dx is in the dependency range +N clusters from the defect Dx, then the spare area where the replacement Ry for the defect Dy is assigned is given a weight of 1. In addition, the spare area with the shortest seek time with respect to the defect Dx is given a weight of 0.5, the spare area with the second shortest seek time is given a weight of 0.4, the spare area with the third shortest seek time is given a weight of 0.3, and the spare area with the longest shortest seek time is given a weight of 0.2. For each spare area, the weights given thereto are summed to obtain a final weight thereof. The final weights of the respective spare areas are compared, and the spare area with the greatest final weight is selected.

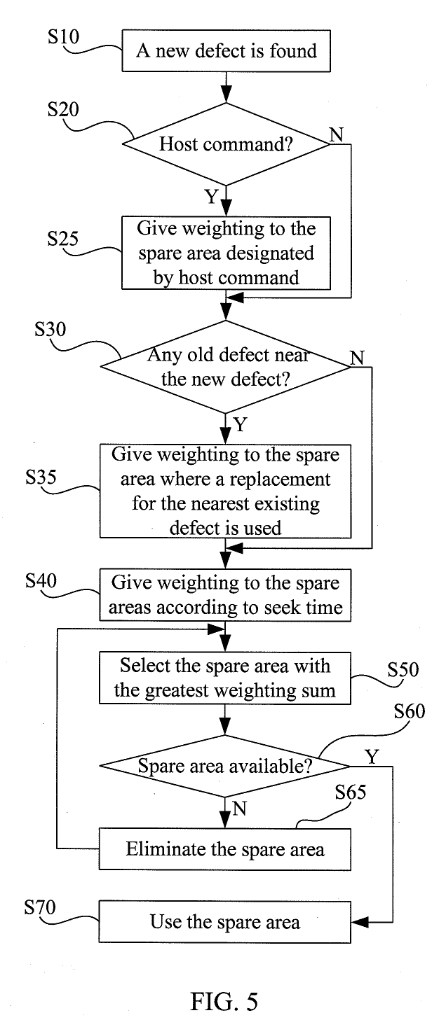

FIG. 5 is a flow chart showing a spare area allocation method in accordance with an embodiment of the present invention. A process of the present embodiment will be described in detail with reference to FIG. 5 and also FIG. 1. In this embodiment, a disc having four spare areas is used as an example. When a new defect D is found on the disc 100 by the defect detection circuit 140 in step S10, the CPU 160 of the disc drive judges if the host issued a command to designate a specific spare area (step S20). If so, a weight (e.g. weight of 2) is given to the specific spare area. If not, the process goes to step S30. In step S30, it is checked if there is an existing defect (old defect, for which a replacement has been assigned) in the vicinity of the new defect. As described, a dependency range (±N clusters from the new defect) is previously defined. It is checked if the nearest old defect for the new defect exists in the dependency range of the new defect D. If so, a weight (e.g. weight of 1) is given to the spare area where the replacement of the old defect is assigned (step S35). If not, the process goes to step S40. In step S40, seek times for the respective spare areas with respect to the new defect are estimated, and weights are given to the spare areas according to the respective seek times. For example, the spare area with the shortest seek time is given a greatest weight (e.g. weight of 0.5), the spare area with the second shortest seek time is given a second greatest weight (e.g. weight of 0.4), the spare area with the third shortest seek time is given a third greatest weight (e.g. weight of 0.3), and the spare area with the longest seek time is given the least weight (e.g. weight of 0.2). Then, various weights given to each spare area are summed. The spare area with the greatest final weight is selected in step S50. In the present embodiment, the selected spare area is checked if it is available in step S60. For example, it is checked that the selected spare area is full or not. If the selected spare area is available, then it is used to allocate the replacement for the defect D (step S70). If the selected spare area is not available (e.g. full), then it is eliminated and selection is re-made among the other spare areas. That is, the process is returned to step S50. Alternatively, the spare area not available can be eliminated from consideration earlier.

By giving weights to the respective spare areas according to various conditions, embodiments of the present invention can efficiently select the most proper spare area to use for the defect.

While the preferred embodiments of the present invention have been illustrated and described in detail, various modifications and alterations can be made by persons skilled in this art. The embodiments of the present invention are therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A spare area allocation method applied in an optical disc having a plurality of spare areas, said method comprising steps of:
giving a weight to each of at least some of the spare areas for allocating at least a replacement for at least a defect in the optical disc; and
selecting one of the spare areas according to the weights given to the respective spare areas.

2. The method of claim 1, wherein the weights are given to the respective spare areas according to seek times from the defect to the respective spare areas.

3. The method of claim 2, wherein the seek times for the respective spare areas are estimated and compared, and the weights are given according to the comparison result of the seek times.

4. The method of claim 3, wherein shorter seek times are given greater weights.

5. The method of claim 1, wherein the weights are given depending on the existence of any old defect in a predetermined range with respect to the defect.

6. The method of claim 5, wherein a weight is given to one of the spare areas when an old defect exists in the predetermined range with respect to the defect and a replacement for the old defect has been allocated in said one of the spare areas.

7. The method of claim 1, wherein the weights are given depending on the existence of any external command designating a specific one of the spare areas.

8. The method of claim 7, wherein a weight is given to one of the spare areas if there is the external command designating said one of the spare areas.

9. The method of claim 1, further comprising eliminating a spare area from the selection for allocating a replacement if the spare area is not available.

10. The method of claim 9, wherein the spare area is eliminated if the spare area is full.

11. The method of claim 9, wherein the eliminating step is executed before the weight giving step.

12. The method of claim 9, wherein the eliminating step is executed after the selecting step, and wherein the method further comprising: repeating the selecting step.

13. The method of claim 1, wherein the weights are predetermined.

14. A spare area allocation system for an optical disc drive having a pick-up head for accessing a disc, the disc having a plurality of spare areas, said system comprising:
a memory storing information of the spare areas; and
a control unit for giving weights to each of at least some of the spare areas according to the information and selecting one of the spare areas according to the weights given to the respective spare areas to allocate a replacement for a defect.

15. The system of claim 14, further comprising a seek-time circuit for estimating a seek time from the defect to each spare area, wherein the control unit gives weights to each spare area according to the respective seek time.

16. The system of claim 15, wherein the search and seek-time circuit further compares the estimated seek times of the respective spare areas, and wherein the control unit gives weights to the respective spare areas according to the comparison result.

17. The system of claim 16, wherein shorter seek times are given greater weights.

18. The system of claim 14, further comprising a search circuit for searching whether there is an old defect in a predetermined range with respect to the defect, and the control unit gives a weight to one spare area to which a replacement for the old defect has been allocated.

19. The system of claim 14, wherein the control unit gives a weight to one of the spare areas if the control unit receives a command designating said one of the spare areas for the defect.

20. The system of claim 19, wherein the control unit eliminates the spare area from the selection for allocating a replacement if the spare area is full.

21. The system of claim 20, wherein the control unit eliminates the spare area before giving the weights.

22. The system of claim 20, wherein the control unit eliminates the spare area after selecting a spare area, and the control unit re-selects one of the other spare areas according to the respective weights thereof.

23. The system of claim 14, wherein the weights are predetermined.

24. A spare area allocation method comprising:
detecting a defect on an optical disc, the optical disc having a plurality of spare areas;
estimating seek time from the defect to at least some of the respective spare areas;
comparing the seek time; and
selecting one of the spare areas with the shortest seek time to allocate a replacement for the defect.

25. A spare area allocation method comprising:
detecting a defect on an optical disc, the optical disc having a plurality of spare areas;
determining whether there is an old defect existing in a predetermined range with respect to the defect; and
if an old defect is found in the predetermined range, selecting the spare area to which a replacement for the old defect has been allocated to allocate a replacement for the defect.

26. A spare area allocation method comprising:
detecting a defect on an optical disc, the optical disc having a plurality of spare areas;
determining whether there is an external command designating a specific one of the spare areas; and
selecting the specific one of the spare areas according to the external command to allocate a replacement for the defect.
